(19) United States
(12) Patent Application Publication
(10) Pub. No.: US 2009/0112341 A1
(43) Pub. Date: Apr. 30, 2009

(54) CONTROL DATA CREATION DEVICE FOR MACHINING, AND PROGRAM THEREFOR

(75) Inventors: Kenji Tanaka, Kanagawa (JP); Lingshi Lin, Kanagawa (JP)

Correspondence Address: MCDERMOTT WILL & EMERY LLP, 18191 VON KARMAN AVE., SUITE 500, IRVINE, CA, 92612-7108, US

(73) Assignee: SODICK CO., LTD., Yokohama (JP)

(21) Appl. No.: 12/301,610

(22) PCT Filed: May 28, 2007
(86) PCT No.: PCT/JP2007/061243

§ 371 Date: Nov. 19, 2008

(30) Foreign Application Priority Data
May 26, 2006 (JP) 2006-146777

(51) Int. Cl. B23H 7/20; G05B 19/19

(52) U.S. Cl. 700/97; 700/162

(57) ABSTRACT

An NC data creation device for creating NC data for forming at least one shape by electric discharge machining using at least two blades formed on one or more tool electrodes. Blade registration means registers the at least two blades (Q). Step registration means registers at least two steps to form the at least one shape (P). Blade assignment means assigns the at least two blades to the at least two steps. NC data creation means creates NC data including the at least two steps. The NC data creation means may create position commands for causing movement of the tool electrodes between two consecutive steps.

### TECHNICAL FIELD

The present invention relates to an electric discharge machining apparatus or method for machining a workpiece. The present invention particularly relates to a control data creation device for machining and a program therefor.

### BACKGROUND

In preparation for machining, a workpiece is set on a work table, and an electrode is attached to a quill or spindle. In many cases, a plurality of electrodes are used for forming a single shape in a workpiece. Reduction in machining precision due to electrode wear is therefore minimized. For example, one electrode is used in rough-machining, and two or more electrodes are used in finishing. For rough-machining, in order to remove material from the workpiece at high speed, current pulses of high energy are supplied to the electrode. For finishing, in order to decrease the surface roughness of the machined shape, current pulses of low energy are supplied to the electrode. For a process for forming the single shape of a required surface roughness on a workpiece, a sequence such as continuing with a finishing step after a rough-machining step can-not be reversed. For a process for forming a plurality of shapes of a required surface roughness, it is possible to select the order in which the machining processes are carried out. For example, it is possible for a process to proceed to finishing steps for all shapes after completion of rough-machining steps for all shapes. Alternatively, it is possible, after completion of a rough-machining step and finishing step for the same shape, for a process to proceed to a rough-machining step for another shape.

In recent years, with the spread of CAM (Computer Aided Manufacture) operators have been able to automatically calculate electrode paths and create NC programs simply by entering shape positions and contours. A term “NC” may refer to numerical control or numerically controlled.

For a process that uses a plurality of electrodes, it is also necessary to specify an electrode that should be used in each step in the NC program. Conventionally, an operator has created a plurality of subprograms for every electrode, using CAM. The operator also created commands to change the electrodes in order to combine the plurality of subprograms, using CAM or an NC device. However, the operation of creating an NC program from a plurality of subprograms carries with it the possibility of creating programming errors.

Unexamined Japanese patent application No. 2002-307241 proposes a method for automatically creating an NC program in order to carry out electric discharge machining by changing a plurality of electrodes. This method determines an order in which the plurality of electrodes are used, registers electrodes actually fitted in a magazine rack, and automatically selects an electrode for each machining step.

In order to reduce electrode changing, it is known to form two or more blades, each of which can independently form a shape in a workpiece, on a single electrode. It is also known to reuse an electrode that has been used in finishing for rough-machining, in order to curtail expenditure. Conventional CAM cannot automatically create an NC program in these types of cases.

### SUMMARY

According to an aspect of the disclosure, an NC data creation device is provided for creating NC data for forming at least one shape using at least two blades formed on one or more tool electrodes. A term “tool electrode” may sometimes be referred to as electrode. The NC data creation device comprises blade registration means for registering the at least two blades, step registration means for registering at least two steps to form the at least one shape, blade assignment means for assigning the at least two blades to the at least two steps, and NC data creation means for creating NC data including the at least two steps.

According to another aspect of the disclosure, a medium encoded with a program for creating NC data is described. The program may be used to form at least one shape using at least two blades formed on one or more tool electrodes. The program can cause a computer to perform the following steps: registering the at least two blades, registering at least two steps to form the at least one shape, assigning the at least two blades to the at least two steps, and creating NC data including the at least two steps.

According to yet another aspect of the disclosure, a control data creation device is provided for creating control data for forming at least one shape using at least two blades formed on one or more tool electrodes. The control data creation device comprises a blade registration module configured to register the at least two blades and a step registration module configured to register at least two steps to form the at least one shape. The control data creation device further comprises a blade assignment module configured to assign the at least two blades to the at least two steps and a control data creation module configured to create control data for machining. The control data includes the at least two steps.

### BRIEF DESCRIPTION OF THE DRAWINGS

FIG. 1 is a block diagram showing an example of an NC data creation system of the present invention.

FIG. 2 is a block diagram showing an example of an NC data creation device in FIG. 1.

FIG. 3(a) is a perspective drawing showing one example of an electrode having a plurality of blades.

FIG. 3(b) is a table showing an example of position and step type for blades in FIG. 3(a).

FIG. 4(a) is a perspective drawing showing another example of an electrode having a plurality of blades.

FIG. 4(b) is a table showing an example of position and step type for blades in FIG. 4(a).

FIG. 5 is a perspective view and a plan view showing an example of a workpiece machined into just a single shape.

FIG. 6 is a perspective view and a plan view showing an example of a workpiece machined into a plurality of shapes.

FIG. 7(a) is a drawing showing one example of a screen for registering steps.

FIG. 7(b) is a drawing showing one example of step registration.

FIG. 8 is a drawing showing another example of step registration.

FIG. 9 is a drawing showing one example of blade registration.

FIG. 10 is a drawing showing another example of blade registration.

FIG. 11 is a drawing showing yet another example of blade registration.

FIG. 12 is a schematic diagram showing the same example as FIG. 11.

FIG. 13 is a table showing one example of blade assignment.

FIG. 14 is a table showing an example of sorting the table of FIG. 13.

FIG. 15 is a flowchart showing an example of creating NC data.

FIG. 16 is a drawing showing one example of step registration.

FIG. 17 is a drawing showing one example of blade registration.

FIG. 18 is a schematic drawing showing one example of blade assignment.

FIG. 19 is a table showing the same example as FIG. 18.

FIG. 20 is a table showing an example of sorting the table of FIG. 19.

### DESCRIPTION OF THE NUMERALS

1 NC data creation system
2 CAD device
3 CAM device
4 NC data creation device
10 input module
20 step registration module
30 blade registration module
40 blade assignment module
50 NC data creation module

### DETAILED DESCRIPTION

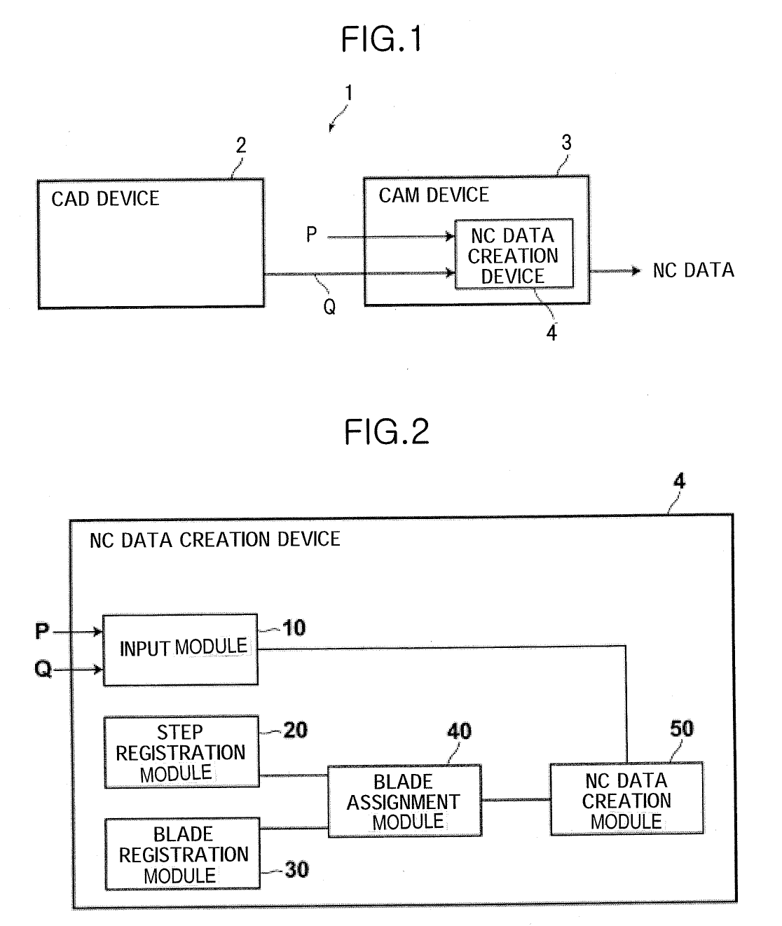

An example of an NC data creation system of the present invention is described with reference to FIG. 1 and FIG. 2. As shown in FIG. 1, the NC data creation system 1 comprises a CAD (Computer Aided Design) device 2 for designing electrodes, and a CAM device (hereinafter referred to simply as CAM) 3 for creating NC data for electric discharge machining of a workpiece using electrodes designed with the CAD device (hereinafter referred to simply as CAD) 2. A program that functions as an NC data creation device of the present invention is installed in the CAM 3.

In preparation for machining, a shank of an electrode is attached to a spindle or quill of an electric discharge machining apparatus using an appropriate electrode holder. The electrode is not in contact with the workpiece, but is positioned extremely close. During machining, electric current pulses are supplied between the electrode and the workpiece for extremely short periods, to remove small quantities of material from the workpiece. By repeating application of electric current pulses, a complementary shape to that of the blade of the electrode is machined in the workpiece. The shape is a hole, indent, groove, cavity, mold etc. The subject technology is not limited to a single blade formed on the electrode. Electrodes having a plurality of blades are also used.

Drawing data for an electrode designed using the CAD 2 is input to the CAM 3 by means of a network or medium, and a position of a blade Q of the electrode is instructed to the CAM 3. A position of a shape P formed on the workpiece is also instructed to the CAM 3. Position of the blade Q and position of the shape P are input to the NC data creation device 4 within the CAM 3.

As shown in FIG. 2, the NC data creation device 4 is provided with input module 10 for inputting position of the blade Q and position of the shape P, and step registration module 20 for registering one or more steps required to form a shape of a required surface roughness in the workpiece. The step registration module 20 specifies a step type for each step, such as rough-machining, finishing, etc. The NC data creation device 4 is also provided with blade registration module 30 for registering blades Q, blade assignment module 40 assigning a blade Q to respective registered steps, and NC data creation module 50 for creating NC data, including all steps. The blade registration module 30 specifies a step type for each blade, such as rough-machining, finishing, etc.

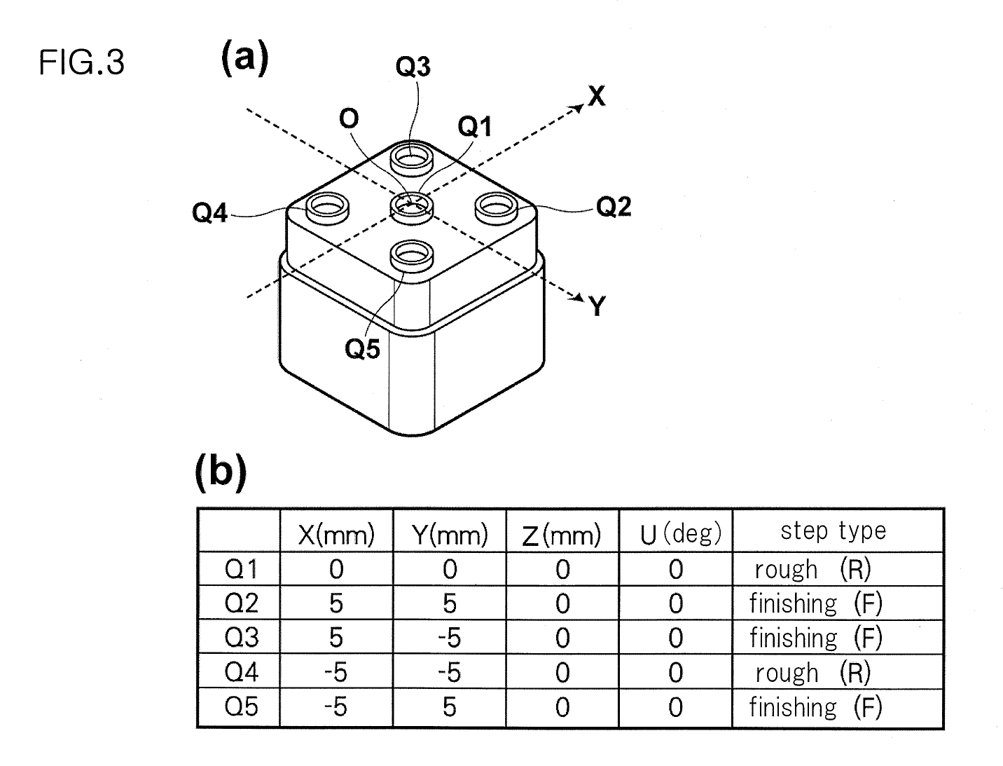

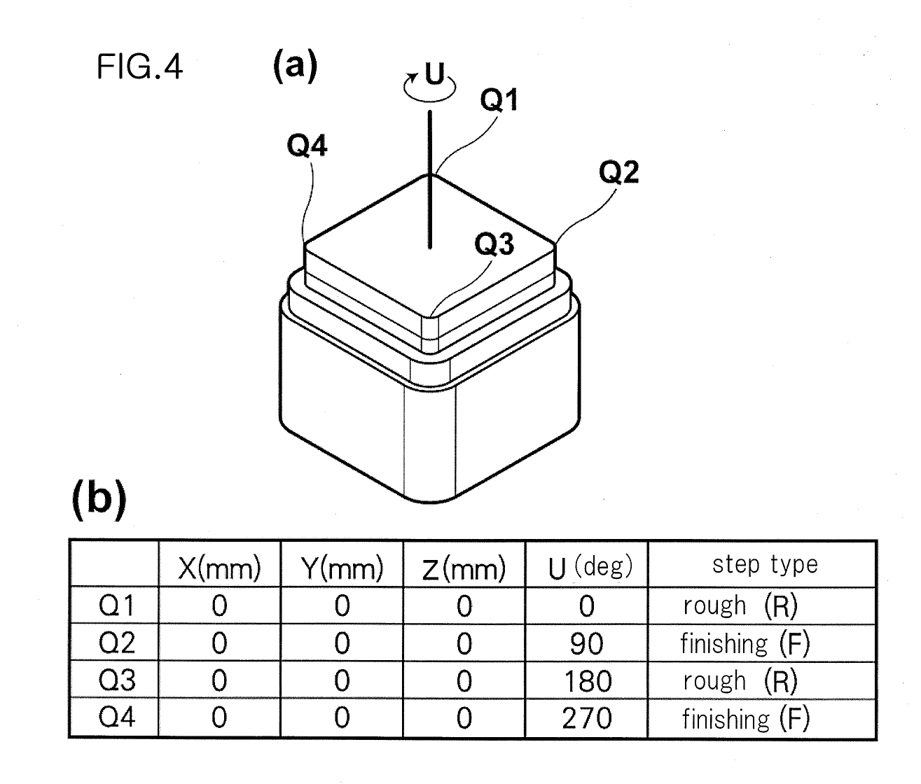

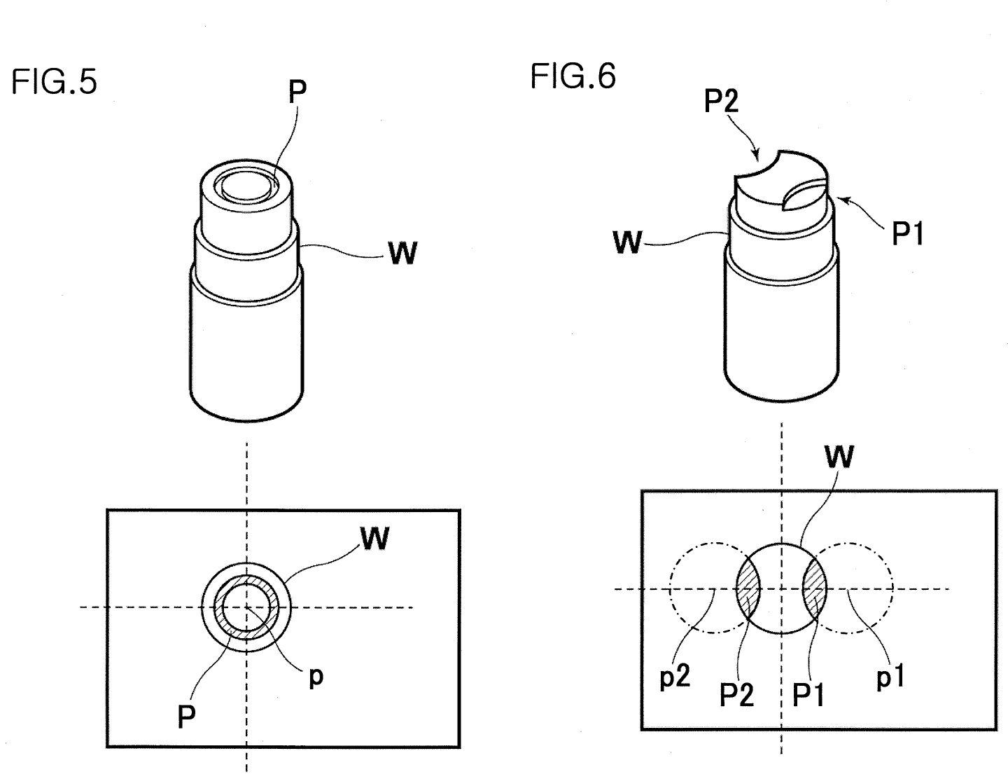

An example of position information input to the input module 10 is described with reference to FIG. 3, FIG. 4, FIG. 5 and FIG. 6.

As shown in FIG. 3(a), in the case of using an electrode having five blades Q1, Q2, Q3, Q4 and Q5 that are the same, coordinates on an XY plane shown in FIG. 3(b) are specified as the position of each blade. A point of origin 0 is set at the center of the electrode. As shown in FIG. 4(a), in the case of using an electrode having four blades Q1, Q2, Q3, and Q4 that are the same, rotation angles of a spindle (U axis) shown in FIG. 4(b) are specified as the position of each blade.

FIG. 5 shows a single shape P machined at the center of a workpiece W. The shape P can be machined using one of the blades in FIG. 3(a). The center of the shape P is specified as position p of the shape P. FIG. 6 shows two shapes P1 and P2 machined on a workpiece W. The imaginary lines in FIG. 6 show positions of the electrode. Positions to which the electrode is moved in order to machine the shapes P1 and P2 are specified as positions p1 and p2 for the shapes P1 and P2.

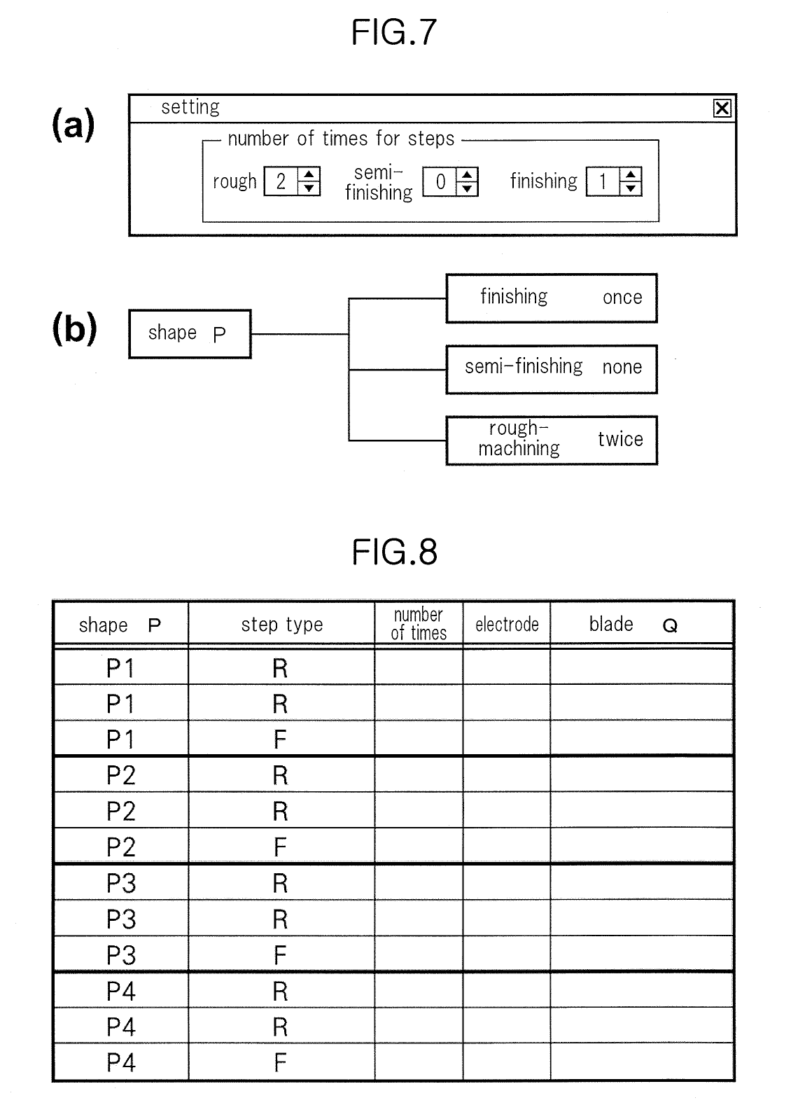

A process for forming a shape of required surface roughness on the workpiece includes a number of steps. The NC data creation device 4 establishes a step for machining the same shape using the same blade as a “step”. Accordingly, it is necessary to have electrode movement between consecutive steps. If the size and shape of the blade of the electrode varies with wear during machining, it is necessary to replace the blade and proceed to the next step. One or more steps required to form a shape of required surface roughness in the workpiece are registered in the step registration module 20. The operator can register a step by specifying three step types, namely rough-machining, semi-finishing and finishing, using the screen shown in FIG. 7(a). The step type is specified based on surface roughness. For a rough-machining step type, a current pulse of the highest possible energy is supplied to the electrode, and a high material removal rate is preferred. Rough-machined surfaces can be tremendously rough. For a finishing step type, current pulses of extremely low energy are supplied to the electrode, and reducing surface roughness is preferred. The material removal rate for a finishing step type is extremely low. For a semi-finishing step type, current pulses having an energy level higher than that for a finishing step type are supplied to the electrode. For machining of the same shape, it is not possible to reverse the order of rough-machining-semi-finishing-finishing. FIG. 7(b) shows registration of a finishing step once and a rough-machining step twice in order to form a shape P of required surface roughness. FIG. 8 shows registration of steps 12 times. In this example, a rough-machining step (R) is registered twice and a finishing step (F) is registered once for each of four shapes P1, P2, P3 and P4.

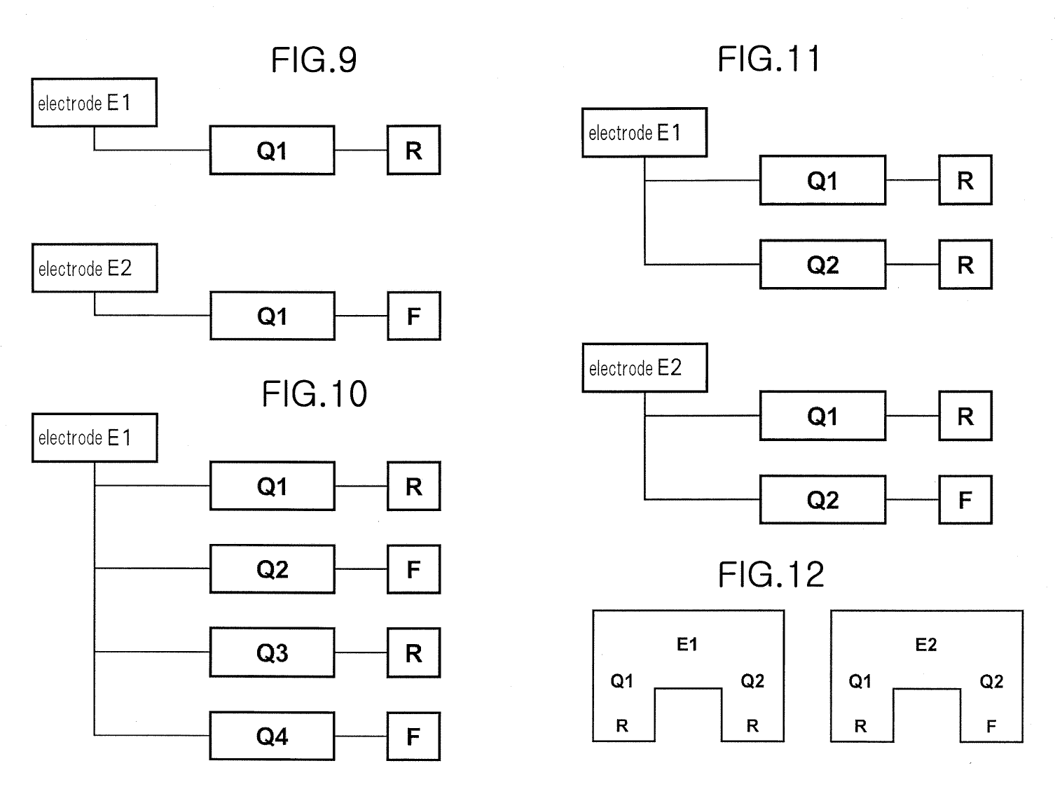

Registration of blades Q is described with reference to FIG. 9, FIG. 10 and FIG. 11. Here, a blade Q can be applied any number of times to steps having the same step type. The registration module 30 registers blades Q of all electrodes that can be used, and specifies a step type for each blade. FIG. 9 shows registration of two blades E1-Q1 and E2-Q1. It is possible to use two electrodes E1 and E2, and each electrode has a single blade. Rough-machining (R) is assigned to the blade E1-Q1, and finishing (F) is assigned to the blade E2-Q1. FIG. 10 shows registration of four blades Q1, Q2, Q3 and Q4. It is possible to use only a single electrode E1 having four blades, with rough-machining (R) being assigned to blades Q1 and Q3, and finishing (F) being assigned to blades Q2 and Q4. FIG. 11 shows registration of four blades E1-Q1, E1-Q2, E2-Q1 and E2-Q2. It is possible to use two electrode E1 and E2, each having two blades Q1 and Q2, with rough-machining (R) being assigned to blades E1-Q1, E1-Q2 and E2-Q1, and finishing (F) being assigned to blade E2-Q2. FIG. 12 shows the same registration as FIG. 11 using illustrated electrodes E1 and E2.

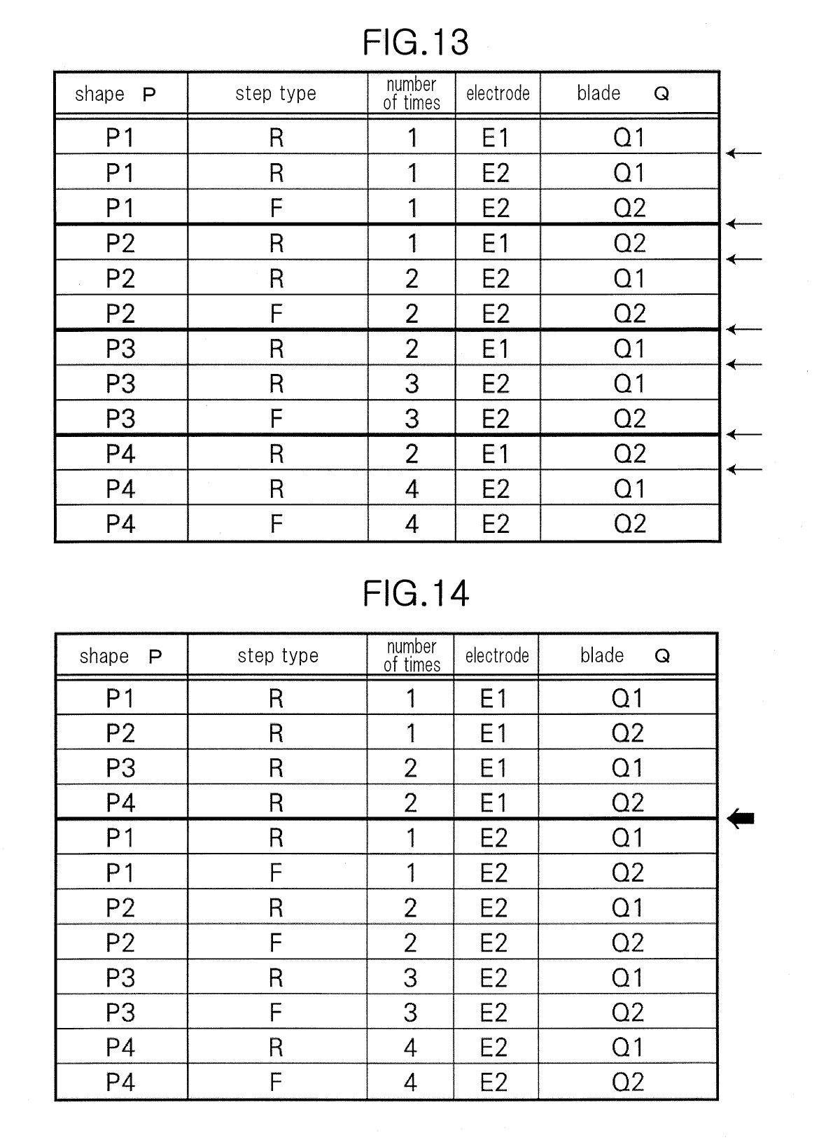

The blade assignment module 40 respectively assigns blades Q that have been registered by the blade registration module 30 to steps registered by the step registration module 20. FIG. 13 shows one example of a sequence where blades E1-Q1, E1-Q2, E2-Q1 and E2-Q2 registered as in FIG. 12 are respectively assigned to steps registered as in FIG. 8. The term “number of times” shown in FIG. 13 indicates how many times a blade is used. Appropriate rules for assigning blades are defined. The blade assignment module 40 assigns blades to finishing steps after blades have been assigned to all rough-machining steps, as described in the following descriptions.

Since the step type for the first step is rough-machining, a blade having a step type of rough-machining is searched for. Blade E1-Q1 is assigned to the first step. Since the step type for the second step is also rough-machining, a blade having a step type of rough-machining is searched for. Blade E2-Q1 is assigned to the second step. Blade E1-Q2 is assigned to the fourth step, and blade E2-Q1 is reassigned to the fifth step. Blades having a step type of rough-machining are assigned to the seventh, eight, tenth, and 11th steps. After that, blades are assigned to steps that have a step type of finishing. A single blade E2-Q2 having a step type of finishing is assigned to the third, sixth, ninth, and 12th steps. A number in the “number of times” column that is excessively large will probably cause lowered precision. The blade assignment module 40 stores “number of times” in order to show this type of possibility.

The NC data creation module 50 determines an order for the steps. The step order may be determined in accordance with the table shown in FIG. 13. The arrows in FIG. 13 show that it is necessary to change the electrodes seven times. The NC data creation module 50 can sort the steps in order to minimize electrode change. The steps in FIG. 13 are arranged in order of “electrode” to create the step table of FIG. 14. The arrows in FIG. 14 show that it is necessary to change the electrodes only once. However, having a step order where rough-machining continues after finishing, for the same shape P, is not permitted. The NC data creation module 50 creates NC data, including commands to change electrode, and all steps, based on the step table of FIG. 13 or FIG. 14. The NC data creation module 50 creates position commands for causing movement of the electrode between two consecutive steps. Position commands are obtained based on the position of the blade Q. In a case where a shape P is changed between two consecutive steps, the position commands are obtained based on position of the blade Q and position of the shape P.

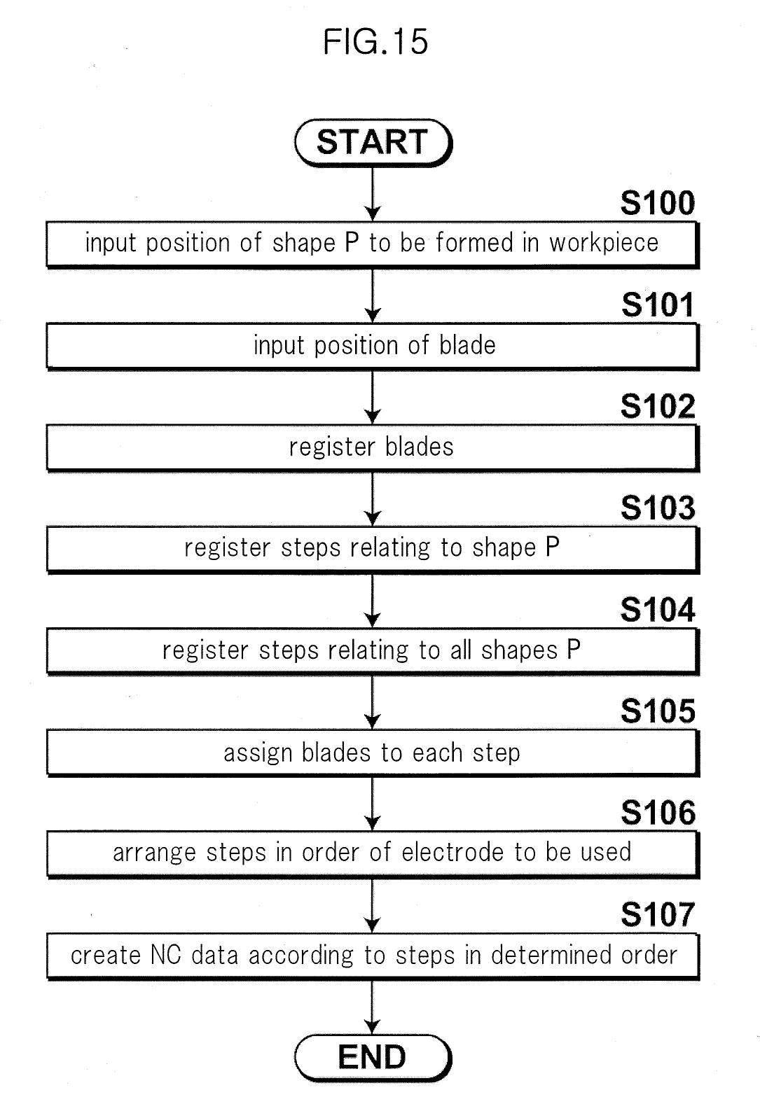

Referring to FIG. 15, an NC data creation process for electric discharge machining using the NC data creation device 4 is described.

First, at step S100, position of a shape P is input using the input module 10. Further, at step S101, position of a blade Q is input using the input module 10. At step S102, all blades are registered using the blade registration module 30. Blade registration includes designation of an electrode on which the blade is formed. Registration of a blade Q also includes designation of a step type capable of using the blade. In FIG. 9, a first blade formed on an electrode E1 to be used for rough-machining, and a second electrode formed on an electrode E2 to be used for finishing, are registered.

In step S103, one or more steps relating to the same shape are registered using the step registration module 20. Step registration includes designation of step type. In FIG. 7(a), a first step for rough-machining, a second step for rough-machining and a third step for finishing are registered. In step S104, as shown in FIG. 8, steps relating to all shapes to be machined are registered. In step S105, as shown in FIG. 13, blades matching a step type are assigned to each step using the blade assignment module 40. At the same time, electrodes on which the blades are formed are specified for each step.

In step S106, steps are arranged in order of the electrodes they use, using the NC data creation module 50. As a result, as shown in FIG. 14, a step order that minimizes tool change is determined. In step S107, NC data that includes steps in a determined order is created. First, a position command for moving the blade Q1 of electrode E1 to the position of shape P1 is created. The position command is calculated based on the position of the blade Q1 and the position of the shape P1. Designation of control axes, such as X axis, Y axis, U axis etc., and movement amount, are included in the position command. Similarly, a position command for insertion between two consecutive steps is created. A command for changing an electrode from E1 to E2 is created between the fourth and fifth steps shown in FIG. 14.

Next, a second embodiment is described. In the second embodiment, a blade Q can be applied to any step type. However, according to one aspect of the disclosure, taking precision into consideration, it is not permissible to assign a blade that has been assigned to a rough-machining step or a semi-finishing step, even once, to a semi-finishing step or to a finishing step. Also, according to one aspect of the disclosure, it is not permissible for a blade that has been assigned to a finishing step even once to be assigned again to a finishing step.

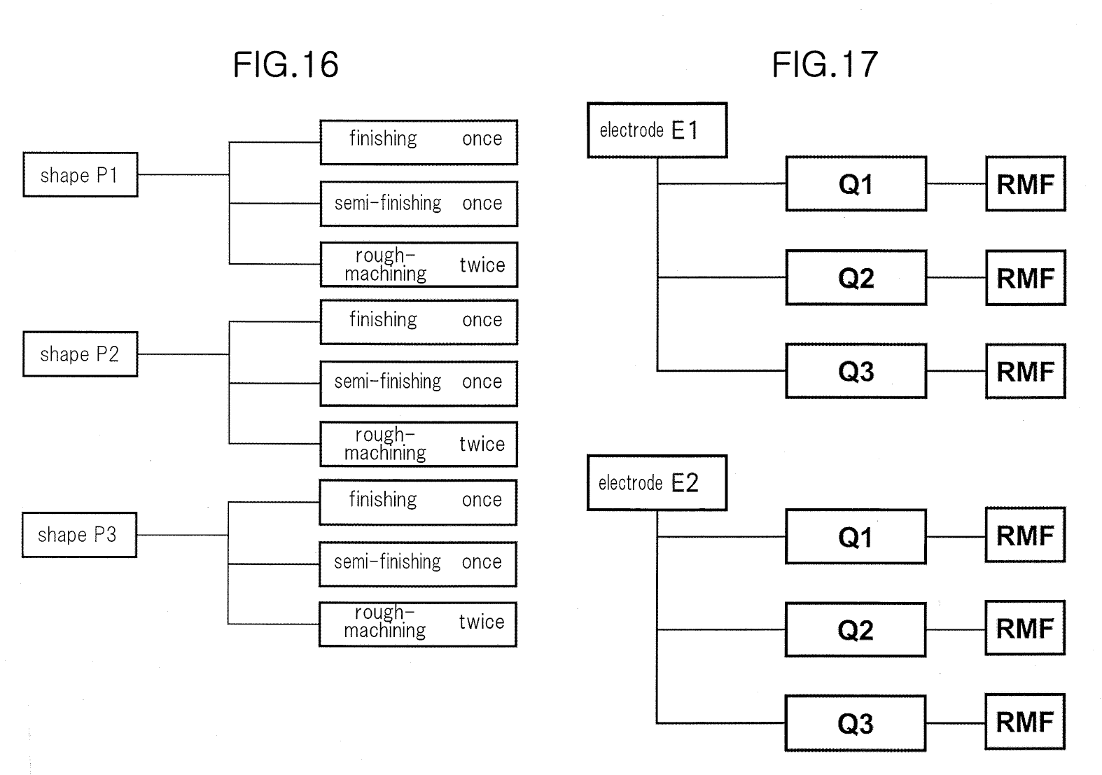

As shown in FIG. 16, the step registration module 20 registers a rough-machining step twice, a semi-finishing step once and a finishing step once for each of three shapes P1, P2 and P3. As shown in FIG. 17, the blade registration module 30 registers six blades, namely E1-Q1, E1-Q2, E2-Q1, E2-Q2, E3-Q1 and E3-Q2. It is possible to use two of the electrodes E1 and E2, each electrode having three blades. Three step types, specifically rough-machining (R), semi-finishing (M), and finishing (F); are specified for each of the blades E1-Q1 E1-Q2 E2-Q1, E2-Q2, E3-Q1 and E3-Q2.

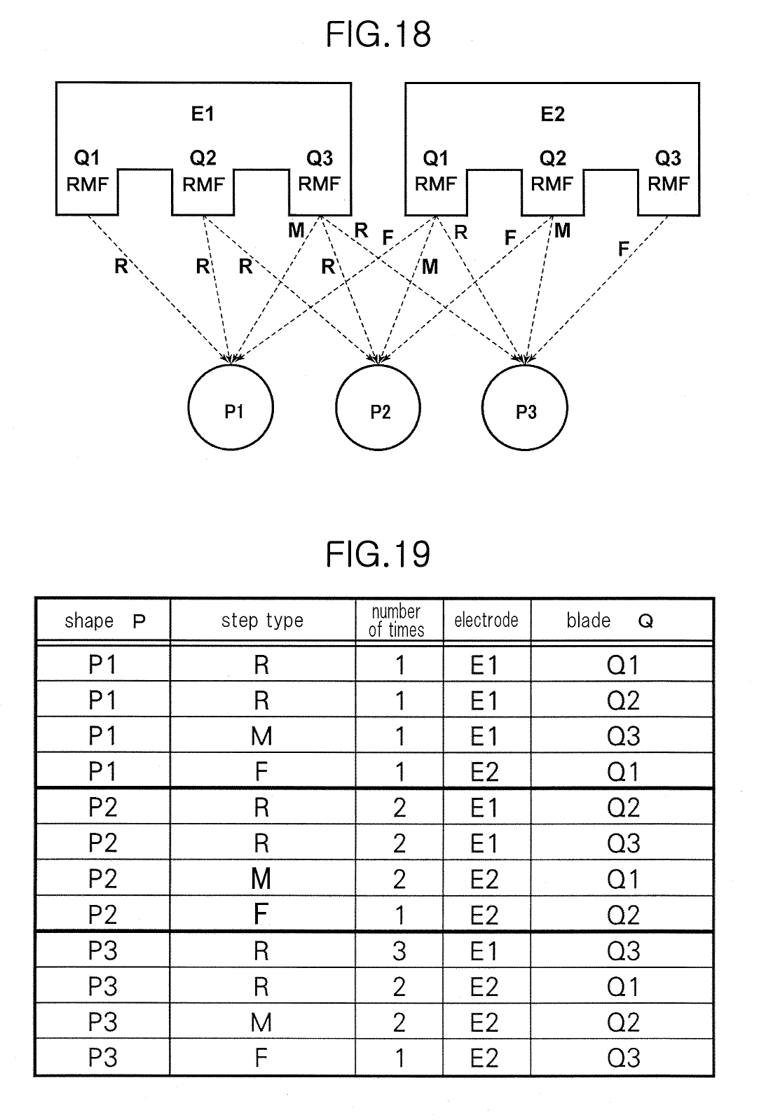

FIG. 18 and FIG. 19 show a method of assigning the blades E1-Q1, E1-Q2, E2-Q1, E2-Q2, E3-Q1 and E3-Q2 of FIG. 17 to the twelve steps in FIG. 16. Assignment rules are determined so that the blades Q are used efficiently. Here, the blade assignment module 40 initially assigns blades to all finishing steps. Next, blades are assigned to all semi-finishing steps. Finally, blades are assigned to all rough-machining steps.

The blade E2-Q3 is assigned to the twelfth step, that is, the finishing step for shape P3. The blade E2-Q2 is assigned to the eighth step, while blade E2-Q1 is assigned to the fourth step. The blade E2-Q2 is assigned to the eleventh step, that is, the semi-finishing step for shape P3. Blade E2-Q1 is assigned to the seventh step, while blade E1-Q3 is assigned to the third step. The blade E2-Q1 is assigned to the tenth step, that is, the rough-machining step for shape P3. Blades are also assigned to the ninth, sixth, fifth, second and first steps.

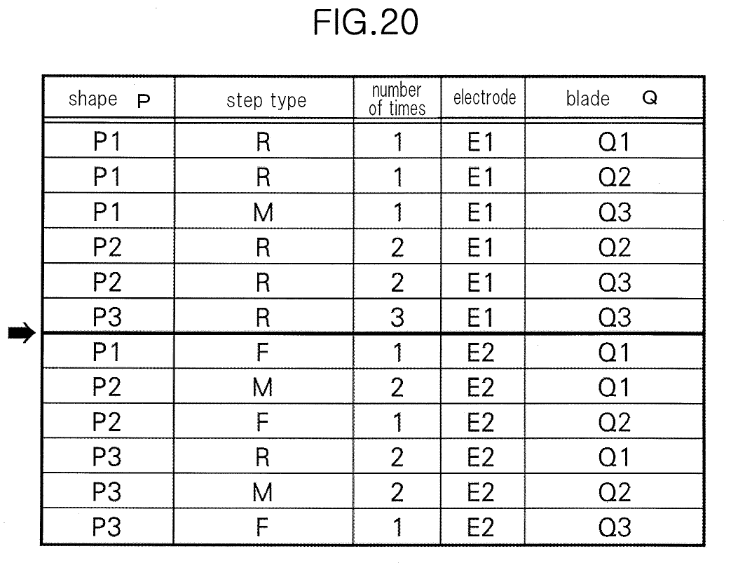

The NC data creation module 50 arranges the steps of FIG. 19 in order of electrodes to be used, to create the step table of FIG. 20.

According to one aspect, the subject technology relates to an electric discharge machining apparatus for machining a conductive workpiece by current pulses, using a tool electrode. According to another aspect, the subject technology particularly relates to an NC data creation device for creating NC data for carrying out electric discharge machining, and to a program for such a device.

According to one aspect, the subject technology can provide an NC data creation device capable of automatically creating NC data for electric discharge machining, even if an electrode having two or more blades is used, and a program for such a device.

According to one aspect, an NC data creation device of the subject technology creates NC data for forming at least one shape (P) using at least two blades (Q) formed on at least one electrode. This NC data creation device comprises blade registration means for registering the at least two blades (Q), step registration means for registering at least two steps required to form the at least one shape (P), blade assignment means for assigning the at least two blades to the at least two steps, and NC data creation means for creating NC data including the at least two steps.

According to another aspect, a program of the subject technology creates NC data for forming at least one shape (P) using at least two blades (Q) formed on at least one electrode. This program can cause a computer to function as blade registration means for registering the at least two blades (Q), step registration means for registering at least two steps required to form the at least one shape (P), blade assignment means for assigning the at least two blades to the at least two steps, and NC data creation means for creating NC data including the at least two steps.

According to one aspect of the disclosure, the step registration means preferably specifies a step type for each of the at least two steps, the blade registration means preferably specifies a step type for each of the at least two blades, and the blade assignment means preferably matches the step type for the at least two blades to the step type for the at least two steps.

According to one aspect of the disclosure, the step registration means preferably specifies a step type to each of the at least two steps, and the blade registration means preferably reassigns a blade, that has been assigned to a step whose step type is finishing, to a step whose step type is rough-machining.

According to one aspect of the disclosure, “at least one shape” can be formed on a single workpiece, or can be formed on a plurality of workpieces. “Step types” may include at least rough-machining and finishing.

According to one aspect of the disclosure, the blade assignment means preferably specifies an electrode for each of the at least two steps, and the NC data creation means preferably arranges the at least two steps in order of the electrode.

According to one aspect of the disclosure, the NC data creation device preferably includes input means for inputting a position of the at least one shape and the positions of the at least two blades. The NC data creation means may create position commands for causing movement of the electrodes, between two consecutive steps, based on the positions of the at least two blades and the position of the at least one shape.

According to one aspect of the disclosure, since a blade formed on an electrode is assigned to a step, and not the electrode, it is possible to automatically create an NC program even if an electrode on which two or more blades are formed is used. In addition, since blade assignment means may reassign a blade that has been used for a finishing step to a rough-machining step, the electrode is used efficiently. Further, since the NC data creation means arranges at least two steps in order of the electrode, change of electrodes is reduced.

The embodiments have been chosen in order to explain the principles of the invention and its practical application, and many modifications are possible in light of the above teachings. It is intended that the scope of the invention be defined by the claims appended hereto.

1. An NC data creation device for creating NC data for forming at least one shape using at least two blades formed on one or more tool electrodes, comprising:
blade registration means for registering the at least two blades;
step registration means for registering at least two steps to form the at least one shape;
blade assignment means for assigning the at least two blades to the at least two steps; and
NC data creation means for creating NC data including the at least two steps.

2. The NC data creation device of claim 1, wherein the step registration means is configured to specify a step type for each of the at least two steps, wherein the blade registration means is configured to specify a step type for each of the at least two blades, and wherein the blade assignment means is configured to match the step type for the at least two blades to the step type for the at least two steps.

3. The NC data creation device of claim 1, wherein the step registration means is configured to specify a step type to each of the at least two steps, and wherein the blade registration means is configured to reassign a blade, that has been assigned to a step whose step type is finishing, to a step whose step type is rough-machining.

4. The NC data creation device of claim 1, wherein the blade assignment means is configured to specify a tool electrode for each of the at least two steps, and wherein the NC data creation means is configured to arrange the at least two steps in order of the tool electrodes.

5. The NC data creation device of claim 1, wherein the blade assignment means is configured to specify a tool electrode for each of the at least two steps, and wherein the NC date creation means is configured to create commands for changing the tool electrodes between two consecutive steps when the two consecutive steps use different tool electrodes.

6. The NC data creation device of claim 1, further comprising input means for inputting positions of the at least two blades.

7. The NC data creation device of claim 6, wherein the NC data creation means is configured to create position commands for causing movement of the one or more tool electrodes, between two consecutive steps, based on the positions of the at least two blades.

8. The NC data creation device of claim 6, wherein the input means is configured to input a position of the at least one shape.

9. The NC data creation device of claim 8, wherein the NC data creation means is configured to create position commands for causing movement of the one or more tool electrodes, between two consecutive steps, based on the positions of the at least two blades and the position of the at least one shape.

10. A medium encoded with a program for creating NC data for forming at least one shape using at least two blades formed on one or more tool electrodes, the program for causing a computer to perform the steps of:
registering the at least two blades;
registering at least two steps to form the at least one shape;
assigning the at least two blades to the at least two steps; and
creating NC data including the at least two steps.

11. A control data creation device for creating control data for forming at least one shape using at least two blades formed on one or more tool electrodes, comprising:
a blade registration module configured to register the at least two blades;
a step registration module configured to register at least two steps to form the at least one shape;
a blade assignment module configured to assign the at least two blades to the at least two steps; and
a control data creation module configured to create control data for machining, the control data including the at least two steps.
